(19) United States
(12) Patent Application Publication
(10) Pub. No.: US 2011/0208738 A1
(43) Pub. Date: Aug. 25, 2011

(54) Method for Determining an Enhanced Value to Keywords Having Sparse Data

(75) Inventors: Amir Bar, Rehovot (IL); Michael Aronowich, Haifa (IL); Nir Cohen, Rishon Le Zion (IL); Gilad Armon-Kest, Amirim (IL); Shahar Siegman, Tel Aviv (IL)

(73) Assignee: KENSHOO LTD., Tel Aviv (IL)

(21) Appl. No.: 13/032,067

(22) Filed: Feb. 22, 2011

Related U.S. Application Data
(60) Provisional application No. 61/306,985, filed on Feb. 23, 2010.

(51) Int. Cl. G06F 17/30

(52) U.S. Cl. 707/737; 707/749; 707/E17.089

(57) ABSTRACT

A method for associating sparse keywords with non-sparse keywords. The method comprises determining from metrics of a plurality of keywords a list of sparse keywords and non-sparse keywords; generating a similarity score for each sparse keyword with respect of each non-sparse keyword; associating a sparse keyword with a non-sparse keyword; and storing the association between the non-sparse keyword and the sparse keyword in a database.

### CROSS-REFERENCE TO RELATED APPLICATIONS

This application claims the benefit of U.S. provisional application No. 61/306,985 filed on Feb. 23, 2010, the contents of which are herein incorporated by reference.

### TECHNICAL FIELD

The invention generally relates to associating a value to a keyword, and more specifically to a system and methods thereto for the determination of, for example, economic values of keywords for advertisement purposes when the keyword does have a frequent occurrence.

### BACKGROUND OF THE INVENTION

The ubiquity of availability to access information using the Internet and the worldwide web (WWW), within a short period of time, and by means of a variety of access devices, has naturally drawn the focus of advertisers. The advertiser wishes to quickly and cost effectively reach the target audience and once reached, enable an effective conversion of the observer of an advertisement into a purchase of goods or services. The advertisers therefore pay search engines, such as Google® or Yahoo!®, for the placement of their advertisement when the keyword is presented by a user for a search.

Typically, a bidding process takes place for popular search keywords so as to get maximum exposure of the advertisements to the users. The more popular the keyword and the more such a keyword is associated with a conversion from its use to an actual sale, the more valuable the keyword is, hence the payment thereto. Popular keywords are therefore generally crowded and expensive, thereby bringing them at many times out of the reach of smaller companies or bidders willing to afford lesser monetary amounts for the search keywords.

As part of the refining of the process of reaching fine metrics on the use of keywords and conversion rates, data about all search keywords is used and is accessible for analysis and research. However, because of the need to effectively manage such popular keywords, much of the focus of the prior art solution was on the handling of less popular or sparse keywords.

Therefore, there is a need in the industry to provide additional opportunity for the use of keywords for the purpose of conversion in general, and specifically making effective use of the tail of the search keywords, i.e., those keywords which are not necessarily popular keywords, and determine their effectiveness for advertisers.

### BRIEF DESCRIPTION OF THE DRAWINGS

FIG. 1 is a flowchart depicting the association process between sparse keywords and popular keywords in accordance with the principles of the invention;

FIG. 2 is a flowchart depicting querying a database for sparse keyword alternatives; and

FIG. 3 is a block diagram of an exemplary computing device according to embodiments of the invention.

### SUMMARY OF THE INVENTION

Certain embodiments of the invention include a method for associating sparse keywords with non-sparse keywords. The method comprises determining from metrics of a plurality of keywords a list of sparse keywords and non-sparse keywords; generating a similarity score for each sparse keyword with respect of each non-sparse keyword; associating a sparse keyword with a non-sparse keyword; and storing the association between the non-sparse keyword and the sparse keyword in a database.

Certain embodiments of the invention also include a method for associating sparse keywords with non-sparse keywords, The method comprises determining from metrics of a plurality of keywords a list of sparse keywords and non-sparse keywords; creating a plurality clusters from the plurality of keywords; generating a similarity score for each sparse keyword with respect of each of the a plurality clusters; associating a sparse keyword with a non-sparse keyword in each cluster of the plurality of clusters; and storing the association between the non-sparse keyword and the sparse keyword in a database.

Certain embodiments of the invention further include a system for associating sparse search keywords with non-sparse keywords. The system comprises a processor connected to a memory by a computer link, the memory having code readable and executable by the processor; an interface connected to the computer link enabling communication of the system to one or more peripheral devices by one or more communication links; and a data storage connected to the processor for storing and retrieving information therein; wherein the processor fetches metrics of a plurality of keywords through at least one of the interface and the data storage; determines from the plurality of keywords a list of sparse keywords and non-sparse keywords; generates a similarity score for each sparse keyword with respect of each non-sparse keyword; associates a sparse keyword with a non-sparse keyword; and stores the association between the non-sparse keyword and the sparse keyword in a database.

### DETAILED DESCRIPTION OF THE INVENTION

In certain cases search keywords may not have sufficient data to indicate their effectiveness with respect to conversion to purchase. However, it is important to attempt to determine the value, for example, economic value, of such sparsely used keywords for advertisement value purposes, as one example. Such keywords, also referred to as long tail keywords, may provide access to additional advertisement conversions at a cost that is a fraction of the cost of highly used search keywords. Certain embodiments of the invention allow association of sparsely used keywords with commonly used keywords, for example, upon determination that such an association is above a predefined threshold. Hence, it enables the estimation of the properties of certain keywords when data is sparse or not accurate enough to provide reliable estimates from the keyword's own data.

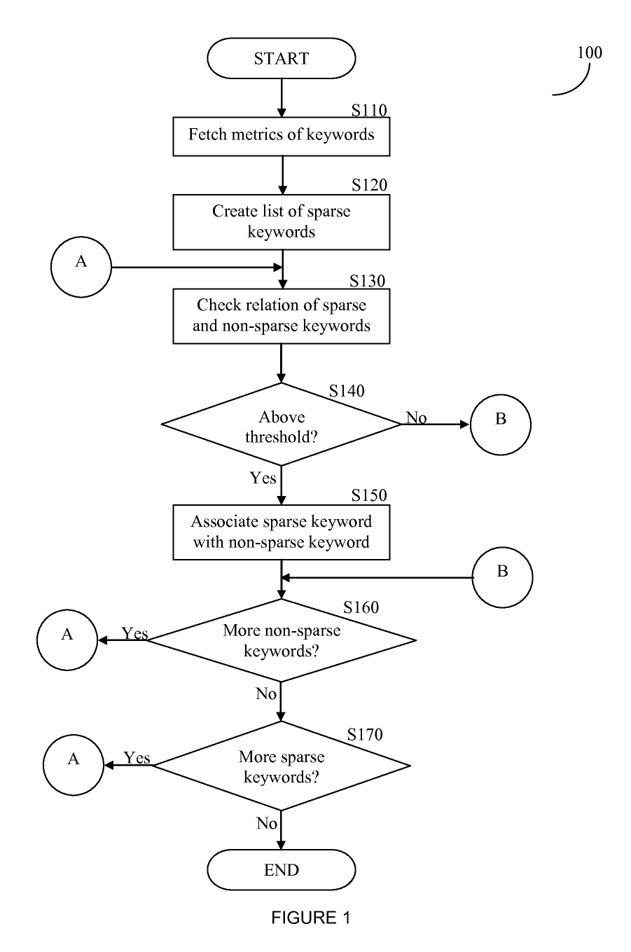

FIG. 1 shows an exemplary and non-limiting flowchart 100, depicting the association process between sparse keywords and popular keywords in accordance with an embodiment of the invention. In S110, metrics respective of search keywords are collected for the purpose of analysis. The metrics may include, for example, the frequency of use of such a keyword, other keywords that were used when the keyword was used, the number of times an advertisement was clicked when the search term was used, the number of conversions to an actual sale, and other parameters as may be applicable. The metrics received are stored in association with the respective keywords in the memory of a computerized system, discussed in more detail herein below.

In S120, a process takes place to identify those keywords that are sparsely used keywords. Firstly, those keywords having relatively small values in the metrics provided are selected, as simply as based on a threshold value, or merely by means of ranking and using a tail of the ranked list. Then, to that effect, a predictive model, such as, but not limited to, a generalized linear model (GLM), non-linear regression models, and the like, may be used for a metric of each fitted keyword and its information content is assessed in terms of statistical significance of the model parameters at a predefined significance level, for example a significance level of 90%. A lack of significance means that the model is meaningless, i.e., no meaningful information can be extracted, and therefore such a word will not have a valid predictive model. Consequently, the list of keywords may now have an additional parameter that distinguishes between those keywords having a significant model, and therefore carrying meaningful information, and those which do not. While a one pair model was discussed, for example profit-position, for the validation process, other possibilities exist without departing from the scope of the invention. For example, three models may be used for validation rather than one, for example, profit-position, clicks-position and cost-position. It should be further noted that other modeling methods producing confidence bounds to the parameters.

In S130, a relationship between a sparsely used keyword and a non-sparsely used keyword is determined to generate a similarity score. The process entails testing the similarity between a word ‘S’ and a target word ‘T’ by calculating the residual sum of squares Δ_{TT} of the model of ‘T’ and the residual sum of squares Δ_{ST} of the model of ‘T’ applied to the data of ‘S’. The similarity is then calculated as that ratio Δ_{TT} to Δ_{ST}. The value of similarity is between ‘0’ and ‘1’, the closer the value is to ‘1’ the higher the degree of similarity.

In one embodiment of the invention, clusters of keywords are created and instead of comparing simply between two keywords, one having an informative model and another that does not, the comparison takes place between a keyword not having an informative model and a cluster of keywords determined to have similar traits through the clustering process. Such a clustering process may take place, for example, as part of S120. In another embodiment of the invention, similarity may be checked based on similarity of conversion or other rates to those of all other keywords that correspond to a given URL. Instead of using a predictive model as discussed hereinabove in more detail, use is made of ratios viewed as success probabilities in binomial experiments, and constructing intervals of their differences, to estimate the extent of similarity.

In S140, it is checked if the similarity is above a threshold, and if so execution continues with S150; otherwise, execution continues with S160. In another embodiment, the check in S140 is based on weighting the data of the non-sparse keywords and/or other sparse keywords using a general monotonically increasing function of the similarity score. It should be noted that as this process takes place, a plurality of associations may be possible, and therefore, associations may take place regardless of the similarity passing a threshold and then selecting the association having the highest similarity. In yet another embodiment, the execution continues to S150, where association takes place only if the highest similarity is also above a predetermined threshold.

In S150, an association between the sparse keyword and the cluster and/or the non-sparse keyword is determined and stored in memory. In S160, it is checked whether additional non-sparse keywords (or clusters) exist that were not yet checked against the sparse keyword, and if so execution continues with S130; otherwise, execution continues with S170. In S170, it is checked whether additional sparse keywords not yet checked exist, and if so execution continues with S130; otherwise, execution ends. Steps S160 and S170 allows to perform a check between the sparse keyword and other non-sparse keywords until determination of the best similarity, or even a plurality of similarities, as they case may be, is achieved. In one embodiment of the invention, a report is displayed or printed.

The non-sparse keywords and associated sparse keywords are now in a database (or any other form of tangible memory) that enables querying for the purpose of getting an alternative keyword which is sparsely used, in lieu of a more expensive popular keyword. Such use is possible as it is determined that such sparse keywords may have a similar advertisement effect for conversions as the non-sparse keyword, based on the similarity score.

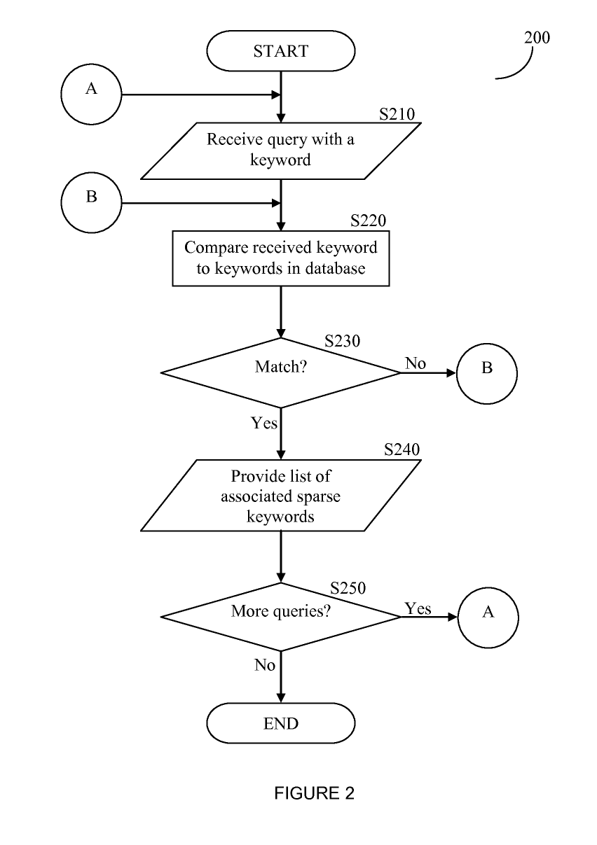

FIG. 2 depicts an exemplary and non-limiting flowchart 200 of querying a database for sparse keyword alternatives. As discussed above, with respect to FIG. 1, a database is created where popular keywords, determined based on the principles above, are associated with sparsely used keywords. In S210, a query is received that contains a keyword. In S220, the keyword is compared against an entry in the database and then in S230 it is determined if a match is found. If a match is found, continues with S240; otherwise, if there are more entries to check execution continues with S220 (shown), but if not execution may end, as there are no more entries in the database to be checked and no match has been found. In one embodiment, a notification is displayed or otherwise reported to suggest that no such match was found. In S240, one or more sparse keywords associated with the searched keyword are provided as a response to the query. In S250, it is checked if there are more queries, and if so execution continues with S210; otherwise, execution terminates.

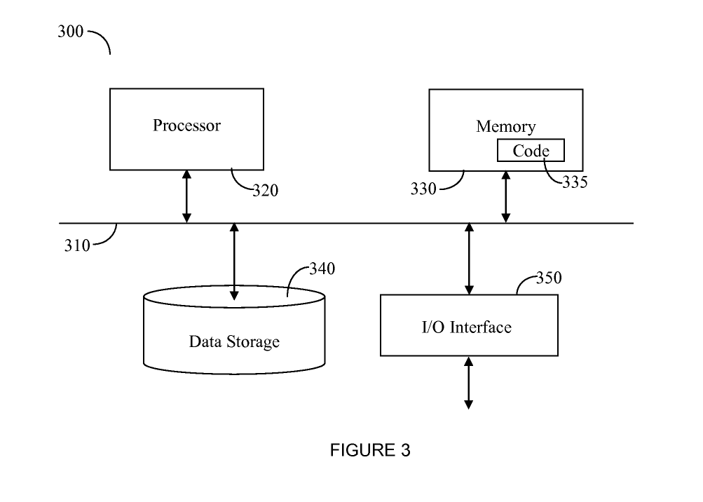

FIG. 3, shows a block diagram 300 of an exemplary and non-limiting computing device according to various embodiments of the invention. Computing device 300 comprises the basic components of a system for the execution of the methods discussed hereinabove, and various embodiments thereto. Typically, computing device 300 includes an interface 310, a processor 320, a memory 330, data storage 340, and an input/output (10) interface 350 to communicate with external networks, systems, or one or more peripheral devices. The interface 310 may be, for example, a bus or other high-seed communication means, connects the processor 320, the memory 330, the data storage 340, and the 10 interface 350, providing a communication link between these components.

The memory 330 can be comprised from volatile and/or non-volatile memory, including but not limited to, random access memory (RAM), read-only memory (ROM), flash memory and others, as well as various combinations thereof. The memory 330 comprises also a memory area 335 where code is stored that when executed performs the methods of the invention. The data storage 340 may include, but is not limited, to removable or non-removable mass storage devices, including but not limited to magnetic and optical disks or tapes. The 10 interface 350 may provide an interface to a display, a printing device, and other output devices, as well as provide a communication link, for example to a network. The network may be, but is not limited to, local area network (LAN), metro area network (MAN), wide area network (WAN), Internet, worldwide web (WWW) and the like.

Therefore, in one exemplary and non-limiting embodiment of the invention keywords are clustered into similar groups. Such clustering can be done by a campaign related structure or as a user-defined grouping of sorts. For each keyword it is then determined which properties should be shared, such as model, averages and the likes, from the cluster. A general similarity, as also described above, may then be performed. This type of similarity is used for predictive models and is based on the assumption that the keywords in the cluster have similar models. Keywords having sufficiently significant parameters, as described above, do not inherit from the cluster at all. In one embodiment, a rejection rule rejects keywords having enough data for the determination of an economic value, even if otherwise they would be considered sparse. This can be performed using a threshold test, or the like. In such a case, such keywords do not inherit data from the cluster they were determined to belong to.

Other sparse or non-sparse keywords are tested by the residual sum of squares test, as described hereinabove in greater detail. Such keywords may inherit or may not inherit according to, for example, a threshold, by quantitatively weighting the cluster's data, or using a model according to the similarity measure.

In one embodiment of the invention, a universal locator resource (URL) similarity may be implemented using the teaching described herein above. A URL similarity may also be referred to as conversion-rate similarity as it identifies those URLs that more frequently are used to convert into, for example, a purchase. This type of similarity is used specifically for post-click metrics, e.g., conversion rate and revenue per conversion. It is based on the assumption that once a user is redirected to an advertiser's site, the user is affected by at least the site's structure, the keyword, and the advertisement leading to the advertiser's site. Therefore, the prediction should be a mix of the keyword's historical data and the advertiser's site historical data.

Hence, for each keyword that redirects to a given site, both the advertiser's site aggregated conversion rate (CRu) and the keyword's conversion rate (CRk) together with their variances (as success probabilities in binomial experiments), as well as the confidence interval [a,b] around their difference p=CRk-CRu are determined. If ‘a’ and ‘b’ are both positive or negative, meaning that the value zero is not in the confidence interval, then the conversion rate, or any other rate, like click-through-rate, of the keyword is statistically different from the URL's conversion rate and cannot belong to the URL's similarity class. If a<0 and b>0, then both conversion rates are considered similar to a certain extent. The degree of similarity is set to be w=0.5−abs(p)/(b−a). In this case the prediction is CRp=(1−w)*CRk+w*CRu. Weighting can be done using the value of ‘w’ or any other monotonic function of ‘w’. This means that the advertiser's site conversion rate participates proportionally to the lack of confidence by which the two conversion rates differ. As more clicks arrive respective of the keyword, the confidence interval shrinks and the weight of the advertiser's site conversion rate in the prediction drops.

In yet another embodiment general similarity is used. General similarity is a similarity measure, e.g., the ratio between sum-of-squared-residuals, and is calculated between each two keywords. Therefore, the method generates a N*N matrix, where N is the number of keywords. The similarity measure is used to weigh data of different keywords data when calculating the models. In this scheme, no clusters are needed to be defined, and there is no binary inheritance of model coefficients. Instead, the data of each keyword is weighted proportionally to its relevance, i.e., similarity-wise, to the modeled keyword. Typically, implementation of this method is both CPU and memory intensive. Therefore, a simplification may be used by pre-clustering the keywords by rules similar to the ones discussed hereinabove, and then using this general similarity scheme only within the generated clusters.

The principles of the invention are implemented as hardware, firmware, software, or any combination thereof. Moreover, the software is preferably implemented as an application program tangibly embodied on a program storage unit or tangible computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for associating sparse keywords with non-sparse keywords, comprising:
determining from metrics of a plurality of keywords a list of sparse keywords and non-sparse keywords;
generating a similarity score for each sparse keyword with respect of each non-sparse keyword;
associating a sparse keyword with a non-sparse keyword; and
storing the association between the non-sparse keyword and the sparse keyword in a database.

2. The method of claim 1, wherein the association of the sparse keyword with the non-sparse keyword is performed if similarity between the sparse keyword and the non-sparse keyword is above a predetermined threshold.

3. The method of claim 1, wherein the association of the sparse keyword with the non-sparse keyword includes weighting data of at least one of non-sparse keywords and sparse keywords using a general monotonic function of the similarity score.

4. The method of claim 1, wherein the method is embodied as a series of instructions on a non-transitory and tangible medium readable by the computing device.

5. The method of claim 1, wherein the determination of the sparse keywords and non-sparse keywords is performed using a fitting predictive model.

6. The method of claim 5, wherein the fitting predictive model is at least one of: a non-linear regression and a generalized linear model.

7. The method of claim 1, wherein the similarity score is computed as a ratio between a residual sum of squares of a model for a non-sparse keyword metrics applied to the data of the sparse keyword metrics and a residual sum of squares of the model of the non-sparse keyword metrics.

8. The method of claim 1, further comprising:
receiving a query containing a keyword;
checking the database for at least a match with a keyword in the database; and
providing, responsive of the query, one or more associated keywords with the query keyword, wherein each of the associated keyword is a sparse keyword.

9. A method for associating sparse keywords with non-sparse keywords, comprising:
determining from metrics of a plurality of keywords a list of sparse keywords and non-sparse keywords;
creating a plurality clusters from the plurality of keywords;
generating a similarity score for each sparse keyword with respect of each of the a plurality clusters;
associating a sparse keyword with a non-sparse keyword in each cluster of the plurality of clusters; and
storing the association between the non-sparse keyword and the sparse keyword in a database.

10. The method of claim 9, wherein the association of the sparse keyword with the non-sparse keyword is performed if similarity between the sparse keyword and at least one cluster is above a predetermined threshold.

11. The method of claim 9, wherein the association of the sparse keyword with the non-sparse keyword includes weighting the data of the plurality of clusters using a general monotonically increasing function of the similarity score.

12. The method of claim 9, wherein the method is embodied as a series of instructions on a non-transitory and tangible medium readable by the computing device.

13. The method of claim 9, wherein the determination of sparse keywords and non-sparse keywords is performed using a predictive model.

14. The method of claim 13, wherein the predictive model is at least one of: a linear regression and a generalized linear model.

15. The method of claim 9, further comprising:
receiving a query containing a keyword;
checking the database for at least a match with a keyword in the database; and
providing, responsive of the query, one or more associated keywords with the query keyword, each of the associated keyword is a sparse keyword.

16. A system for associating sparse keywords with non-sparse keywords, comprising:
a processor connected to a memory by a computer link, the memory having code readable and executable by the processor;
an interface connected to the computer link enabling communication of the system to one or more peripheral devices by one or more communication links; and
a data storage connected to the processor for storing and retrieving information therein; wherein the processor fetches metrics of a plurality of keywords through at least one of the interface and the data storage; determines from the plurality of keywords a list of sparse keywords and non-sparse keywords; generates a similarity score for each sparse keyword with respect of each non-sparse keyword; associates a sparse keyword with a non-sparse keyword; and stores the association between the non-sparse keyword and the sparse keyword in a database.

17. The system of claim 16, wherein the association of the sparse keyword with the non-sparse keyword is performed if similarity between the sparse keyword and the non-sparse keyword is above a predetermined threshold.

18. The system of claim 16, wherein the association of the sparse keyword with the non-sparse keyword includes weighting the data of the non-sparse keywords and/or other sparse keywords using a monotonic function of the similarity score.

19. The system of claim 16, wherein the processor further creates clusters from the plurality of keywords.

20. The system of claim 16, wherein processor enables the determination of sparse keywords and non-sparse keywords using a predictive model.

21. The system of claim 20, wherein the predictive model is at least one of a linear regression a generalized linear method.

22. The system of claim 16, wherein the system is adapted to return a list of spare keywords associated with an input keyword included in a received a query.
